(19) United States
(12) Patent Application Publication
(10) Pub. No.: US 2012/0050103 A1
(43) Pub. Date: Mar. 1, 2012

(54) SYNTHETIC APERTURE DEVICE FOR RECEIVING SIGNALS OF A SYSTEM COMPRISING A CARRIER AND MEANS FOR DETERMINING ITS TRAJECTORY

(75) Inventor: Marc REVOL, Upic (FR)

(73) Assignee: Thales, Neuilly-Sur-Seine (FR)

(21) Appl. No.: 13/190,170

(22) Filed: Jul. 25, 2011

(30) Foreign Application Priority Data
Jul. 10, 2010 (FR) FR1003026

(51) Int. Cl. G01S 19/29; G01S 1/30

(52) U.S. Cl. 342/357.68; 342/394

(57) ABSTRACT

Synthetic aperture antenna device for receiving signals of a system comprising a carrier and means for determining its trajectory, comprising, for each signal respectively associated with a spatial direction, processing means adapted for generating a signal with stationary phase over a time window corresponding to the distance traversed by the device during the duration of coherent integration, after demodulation of the said signal received, the said processing means comprising correction means adapted for correcting the carrier phase of the said signal.

The invention pertains to a receiver of signals of a system, intended to improve the operating robustness in the presence of sources of jamming and of interference, as well as reflected paths of the signals.

A satellite navigation system uses a constellation of satellites which rotate about the earth in very precisely determined orbits. Thus, it is possible to ascertain at any instant the position of any satellite. The orbits of the satellites are chosen in such a way that at any time, 6 to 12 satellites are visible from any point of the earth. Each satellite emits several radioelectric signals of determined type of modulation and frequencies. On the ground or on a land, sea or air vehicle, a receiver receives the signals emitted by visible satellites.

An airborne satellite navigation system receiver measures the duration of propagation required for a time mark transmitted by a satellite to reach it. The time marks are coded on carrier waves by the technique of phase modulation. Each satellite thus transmits a set of its own specific pseudo-random codes. A replica of the sequence of the code is generated by the receiver and the shift that the replica must undergo so as to coincide with the code received corresponds to the duration of propagation of the signal in order to traverse the satellite-receiver distance. This duration multiplied by the speed of light in the medium crossed gives a distance measurement called a pseudo-distance. On the basis of the measurements of the pseudo-distances separating it from each visible satellite, and of the knowledge of the position of the satellites, the receiver deduces its precise position in terms of latitude, longitude, and altitude in a terrestrial frame by numerical resolution akin to triangulation. On the basis of the (Doppler) phase measurements of the carriers, and of the precise knowledge of the apparent speed of the satellites, the receiver calculates the speed precisely. It can also deduce therefrom the date and the precise time in the temporal frame of the satellite navigation system.

The reception of the satellite signals and the precision of the measurements remains very sensitive, despite the widening of the spreading codes and the increase in transmission powers, to the presence of sources of jamming and of interference, as well as to the existence of reflected paths.

One way of improving the robustness of the receivers involves the use of array antennas. This field is beginning to be developed within the framework of satellite navigation system military receivers (numerical CRPA antenna) and ground stations. However, these solutions entail antenna sizes that are constraining, and substantially increase the hardware complexity for the RF radiofrequency stages of the receiver (as many RF channels as antenna elements) as well as the calculational load (real-time inversion of the interspectral matrix for intermediate frequency).

An aim of the invention is to limit the complexity of such antennas, while reducing their cost.

According to one aspect of the invention, there is proposed a synthetic aperture antenna device for receiving signals of a satellite navigation system comprising a carrier and means for determining its trajectory, the said device comprising, for each signal respectively associated with a spatial direction, processing means adapted for generating a signal with stationary phase over a time window corresponding to the distance traversed by the device during the duration of coherent integration, after demodulation of the said signal received, the said processing means comprising correction means adapted for correcting the carrier phase of the said signal.

Such a device makes it possible to limit the complexity of the antennas, while reducing their cost. Furthermore, the synthetic antenna processing allows significant directivity gains to be obtained in any direction of aim, incomparable with those achievable by array antennas on account of the bulkiness and of the number of elementary antennas which would then be necessary, thus making it possible not only to improve the reception sensitivity on the direct paths from the emitter, but also makes it possible to detect and to isolate its paths reflected in the other directions. On account of the simplicity of the proposed synthetic antenna processing, it is possible to carry out the simultaneous tracking for their various directions of arrival of the direct signals, associated with each satellite, and of the signals reflected on the ground.

In one embodiment, the said correction means comprise, in order to correct the carrier phase of the said signal in the acquisition phase or in the tracking phase:
first means for determining a speed of displacement vector of the device;
means of orthogonal projection of the said speed of displacement vector of the device in the direction of the said signal;
a first numerically-controlled oscillator receiving as input the said orthogonal projection;
a multiplier for multiplying the signal delivered by the said first numerically-controlled oscillator and the complex base components of the signal received, obtained after demodulation of the carrier phase; and
first means of coherent integration of the signal delivered by the said multiplier over a time interval of a duration T that is less than the time of traversal by the antenna of 100 wavelengths of the carrier frequency, and less than a maximum of 10 seconds.

Such an embodiment makes it possible to retain the conventional architecture of a satellite navigation system receiver tracking loop. The phase compensation is carried out at low rate after correlation by the local code, using the measurements provided by the code loop and phase loop used for tracking the satellite signals, in contradistinction to more complex solutions where the compensation is carried out at the level of the RF (radio-frequency) or IF (intermediate frequency) stages.

According to one embodiment, the signal comprising a sub-carrier phase, the said correction means are, furthermore, adapted for correcting the sub-carrier phase of the said signal.

Thus, it is possible to construct a synthetic antenna on the basis of the sub-carrier of the BOC-type modulation signal whose larger wavelength makes it possible to carry out the processing at a lower rate or to permit larger speeds of displacement of the carrier than in the case of the carrier correction.

In one embodiment, the sub-carrier phase comprising a modulation of the spreading codes of BOC type, the said correction means comprise:
means of complex demodulation of the sub-carrier phase
second means of short integration of the signal delivered by the said means of complex demodulation serving for the measurement of the carrier phase;
second means for determining a trajectory reference for the said device so as to determine the evolution of the phase of the signal received corresponding solely to the displacement of the said device;
means for estimating the relative displacement of the device corresponding to the projection of the speed of displacement of the carrier in the direction of the signal received on the basis of the said trajectory reference for the said device;
first means for calculating a sub-carrier phase correction for the signal corresponding to the relative displacement of the carrier, slaved in time to the time received;
first multiplication means for performing the complex multiplication of the output signal of the said second means of short integration and of the said first means for calculating sub-carrier phase correction; and
third means of long integration of the signal delivered by the said second means of short integration serving for the measurement of the sub-carrier phase;
means for measuring the sub-carrier phase.

This processing is particularly adapted to the case of the new signals of satellite navigation systems of BOC or AltBOC type for carriers of the device having high speeds. In this particular case, the apparent length of the antenna relative to the sub-carrier wavelength is lower, thereby leading to wider directivity pencils (for one and the same duration of coherent integration) and therefore to better stability of the reception channels.

For example, the said means of complex demodulation of the sub-carrier phase comprise:
a second numerically-controlled oscillator for generating the local BOC-type code slaved in time to the time received;
second multiplication means for performing the complex multiplication of the signal received and of the complex BOC-type code generated locally.

Thus, a complex demodulation of the sub-carrier of the BOC (or AltBoc) modulation is carried out from which it is possible to directly estimate the phase, representative of the delay of the BoC (or AltBoc) code. The signal of complex BOC type equals BOC_cos+j BOC_sin.

According to one embodiment, the sub-carrier phase comprising a modulation of the spreading codes of BOC type, the said correction means comprise:
means of complex demodulation of the sub-carrier phase
second means of short integration of the signal delivered by the said multiplier serving for the measurement of the carrier phase;
second means for determining a trajectory reference for the said device so as to determine the evolution of the phase of the signal received corresponding solely to the displacement of the said device;
means for estimating the relative displacement of the device corresponding to the projection of the speed of displacement of the carrier in the direction of the signal received on the basis of the said trajectory reference for the said device;
first means for calculating a sub-carrier phase correction for the signal corresponding to the relative displacement of the carrier, slaved in time to the time received;
third means for multiplying the signals delivered at the output of the second means of short integration and of the first calculation means;
spatial adaptive processing means for performing a temporal filtering of the demodulated complex signal, delivered at the output of the said third multiplication means, on the basis of the said weightings and of the said sub-carrier phase measurement;
second means for calculating weighting coefficients for the said spatial adaptive processing means, applied on the basis of the signal delivered at the output of the said third multiplication means; and
means for measuring the sub-carrier phase of the output signal of the said spatial adaptive processing means.

The adaptive processing applied to the temporal samples is equivalent to a spatial adaptive processing which would be applied to antenna discrete elements. This makes it possible to preserve the directivity gain in the directions of aim, while rejecting the sources of strong interference situated in the other directions.

According to another aspect of the invention, there is also proposed a method of receiving by synthetic aperture antenna signals of a satellite navigation system comprising a carrier and means for determining its trajectory, in which, for each signal respectively associated with a spatial direction, a processing is performed, adapted for generating a signal with stationary phase over a time window corresponding to the distance traversed by the device during the duration of coherent integration, after demodulation of the said signal received, the said processing comprising a correction of the carrier phase of the said signal.

According to one mode of implementation, the said correction of the carrier phase of the said signal comprises, in the acquisition phase or in the tracking phase:
a determination of a speed of displacement vector for the said antenna;
an orthogonal projection of the said speed of displacement vector in the direction of the said signal;
a generation of a signal for correcting the phase of the carrier performed by a digital oscillator controlled phase-wise on the basis of the speed of displacement of the antenna in the direction of the signal;
a multiplication of the said corrected signal and of the signal received in terms of complex base components, obtained after demodulation of the carrier phase; and
a coherent integration of the result of the said multiplication over a time interval of a duration T that is less than the time of traversal by the antenna of 100 wavelengths of the carrier frequency, and less than a maximum of 10 seconds.

In one mode of implementation, the signal comprising a sub-carrier phase, the said correction is, furthermore, adapted for correcting the sub-carrier phase of the said signal.

The phase correction thus carried out makes it possible to compensate the evolution of the phase of the signal corresponding to the motion of the carrier in the direction of aim, so rendering it equivalent to that which would be delivered in the case of a displacement contained in a plane orthogonal to the direction of aim, thus ensuring that the signals which arrive in the direction of aim are in coherence.

The invention will be better understood on studying a few embodiments described by way of wholly non-limiting examples and illustrated by the appended drawings in which:

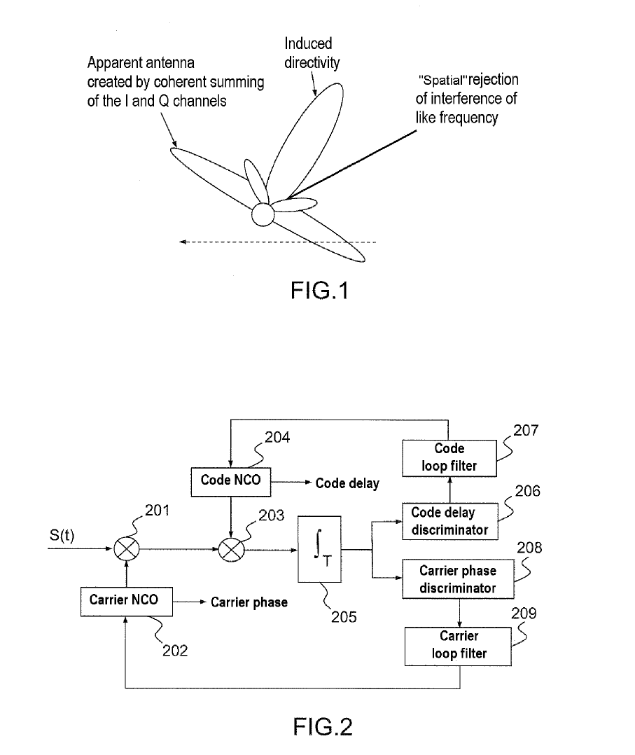

FIG. 1 schematically illustrates the simple directivity effect;

FIG. 2 schematically illustrates the principle of slaving of the code phase and carrier phase tracking loops;

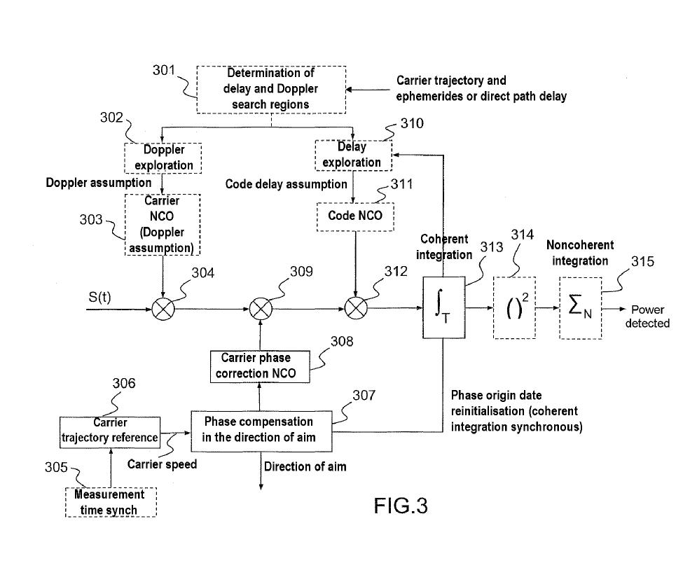

FIG. 3 schematically illustrates an embodiment of the invention for coherent acquisition on simple carrier;

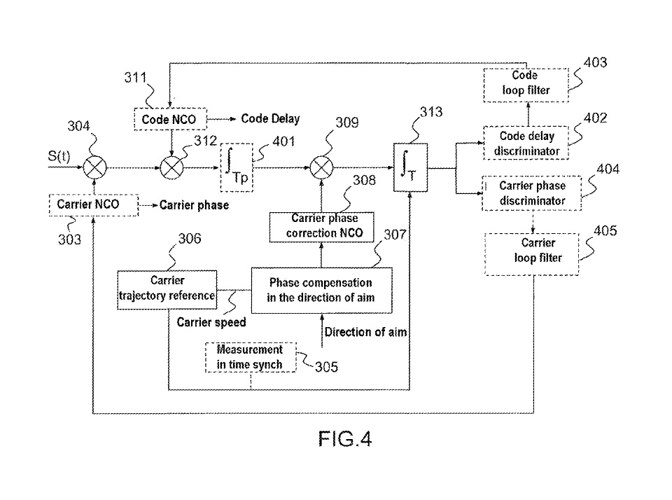

FIG. 4 schematically illustrates an embodiment of the invention for coherent tracking on simple carrier;

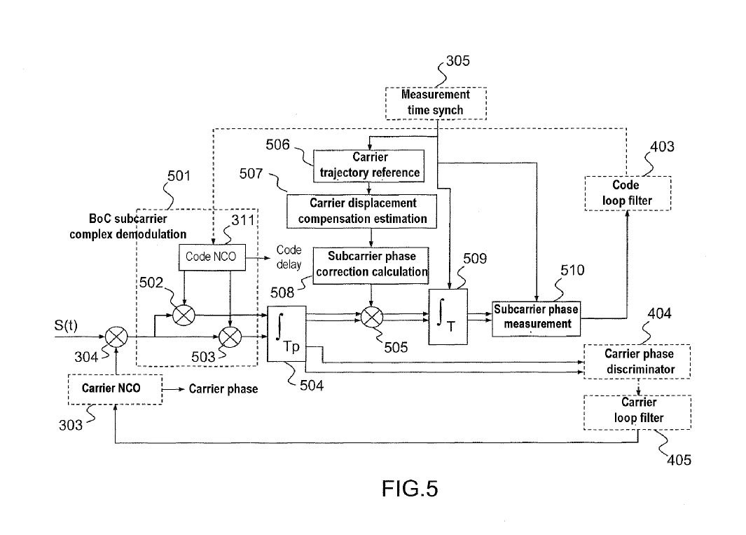

FIG. 5, schematically illustrates an embodiment of the invention on sub-carrier frequency of BOC type;

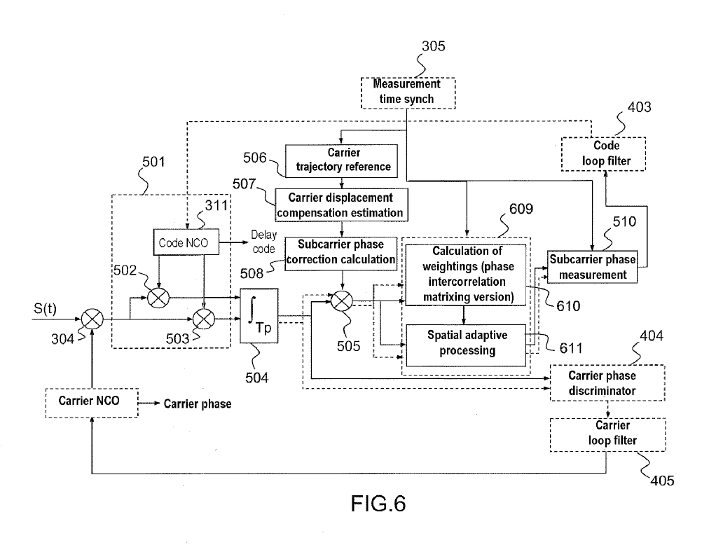

FIG. 6 schematically illustrates another embodiment on sub-carrier frequency of BOC type by adaptive processing.

In all the figures, the elements having the same references are similar.

Generally, one speaks of a “synthetic antenna”, as illustrated in FIG. 1, when a deficient resource, such as a lack of space, or an operating constraint, is replaced with time. This assumes a certain spatial stability of the scene: it may involve perfect coherence (SAR, SAS, Seismic or Echography), or only second-order spatial stationarity (aperture synthesis in radioastronomy).

Synthetic techniques are known in the fields of mapping, surveying or echography.

Indeed, the synthetic antenna, originally applied to radar or SAR (Synthetic Aperture Radar) mapping, utilizes the inherent motion of the vehicle carrying the physical antenna. It fashions artificially or simulates an antenna of large size whose geometry corresponds to the space covered by the antenna during its displacement. The content of the documents “Communication with parametric array”, by L. Kopp, IEEE Trans, Ocean Engineer, January 2000, Antenne Synthetique Radar et Sonar, and “Synthetic Aperture Radars—a paradigm for technology evolution”, by C. A. Wiley, 1985, IEEE AES-21 Trans, pp. 440-443, illustrate this knowledge.

Similarly, this principle has been used, but in a more belated manner, for mapping seabeds. The problem of SAS for Synthetic Antenna Sonar, is complicated by the control of the navigation of the carrier platform, as illustrated by the content of the documents “Comparison of sonar system performance achievable using synthetic aperture techniques with the performance achievable by more conventional means” by L. J. Cutrona, Journal of the Acoustic Society of America, 1975, 58(2), pp. 336-348, and “Special Issue on Acoustic Synthetic Aperture Processing”, IEEE Ocean Engineering Trans., Vol. 17, January 1992.

The application to the field of satellite navigation offers new horizons on account of the need to respond both to constraints limiting the complexity of increasingly integrated receivers, and to the requirement to ensure expanding integrity and continuity of the measurements produced.

In the case of satellite navigation system signals, the signal emitted is controlled in terms of phase and delay. Everything happens as if employing a reception antenna whose geometry corresponds to the whole set of positions occupied by the reception antenna. It is thus possible to reconstruct the reception diagram a posteriori by summing the signals received at the various sampling recurrences, taking account of the motion of the emitter.

It is conceptually easier to envisage a synthetic antenna if one begins by considering the case in which the emitter is fixed and the receiver moving occupying successive positions. Of course, the invention also applies to the case in which the receiver is fixed and the emitter moving.

Let us consider a fixed transmitter and the series {(rₙ(t))}, (n varying from 1 to N) of signals received on the reception antenna at successive instants, at which the receiver occupies variable positions. If the signals in question are simply summed, this is equivalent to fashioning the signal which would actually be received by this same sensor upon reception at the same instant on an antenna with N sensors on which the signal were applied simultaneously to all the emitters. If the positions of the sensors are distributed over a straight line, the previous operation corresponds to pointing the emission antenna at infinity orthogonally to the displacement.

It is, of course, also possible to apply phase shifts {τₙ}_{n=1,N} to the previous signals, it being possible for these phase shifts to be calculated so as to orient the virtual reception antenna in the direction of the tracked satellite (channel formation). This possibility of orienting the antenna in an arbitrary position constitutes the main benefit of the synthetic antenna.

Nevertheless there is still a difference between a synthetic antenna and a true antenna: the electronic noise for each measurement is increased with respect to what it would be if the complete emission antenna were actually employed. In detection the losses are of a \sqrt{N} ratio.

Moreover, to implement such a processing, it is necessary to ascertain the trajectory traversed by the antenna for the duration of coherent integration, with a precision of better than λ/8, λ being the wavelength of the carrier or of the sub-carrier.

Passive Synthetic Aperture Antenna or PSAA processing, distinct from the active synthetic antenna or ASAA processing used in radar and in sonar, but calling upon the same physical principle, applied to the reception or to the emission of the signals of a satellite navigation system, affords a response to this complexity. Indeed, this processing may be carried out on the basis of a single elementary antenna, or of a plurality (array antenna) if it is already available, and limits the increase in complexity as regards the hardware or the internal processing of the receiver. Furthermore, this processing provides a robust solution avoiding any form of calibration ordinarily related to spatial processing on the basis of elementary antennas disposed in an array. It exploits the known displacement of the carrier, i.e. of the device itself (for example arising from an orbitography in the case of a satellite, or from an inertial or odometric reference, or indeed cartographic references) and the temporal coherence of the phase of the signals in order to make a virtual antenna.

Furthermore, the synthetic antenna processing makes it possible to obtain significant directivity gains in any direction of aim, incomparable with those achievable by array antennas on account of the bulkiness and of the number of elementary antennas which would then be necessary. Thus, it is not only possible to improve the reception sensitivity on the direct paths from the emitter, but also to detect and to isolate its paths reflected in the other directions. On account of the simplicity of the proposed synthetic antenna processing, it is possible to carry out the tracking simultaneously for various directions of arrival of the direct signals associated with each satellite, and of the reflected signals, on the ground.

The simultaneous use of the direct paths and of the reflected paths then offers multiple advantages for carrying out navigation characterized by the absence of active emissions:
improvement to the robustness of location on the basis of the direct signals,
relative navigation with respect to ground obstacles characterized by bright spots, facilitating the autonomy of the navigation of the craft, use of the characteristic bright spots for a map-based navigation, and determination of the relative distances, and
the location system is entirely passive.

Tight hybridization, known and conventionally used in the case of the hybridized satellite navigation systems with an inertial reference, carries out only partially the functionalities of a synthetic antenna according to the invention:
tight hybridization relies solely on the measurements arising from the PLL-type receiver tracking loops to extract the phase measurements. It makes it possible to improve the coherent integration only in the direction of the signal undergoing tracking, initialized and locked in the acquisition phase onto the main path.
it does not make it possible to constrain the orientation of the coherent integration in different directions from that of the signal under tracking corresponding in general to the direct path,
tight coupling operates only in steady tracking and is not used for improving the detection (the acquisition) of weak signals. Notably, it does not allow any acquisition to be carried out on reflected signals.

The proposed synthetic antenna processing makes it possible to carry out the coherent integration or focusing of the signals obtained after correlation, this in any direction whatsoever, notably those corresponding to multipaths, equally well in the acquisition phase and in the tracking phase. The sampling over time of the phase actually makes it possible to carry out a complete processing for compensating the phase of the wave received in any direction whatsoever, or indeed to carry out, as proposed, adaptive optimal processing with a view to affording additional robustness in relation to strong interference sources.

In the known devices, the coherent integration carried out on the signal after correlation, in the acquisition and not the tracking phase, amounts to creating an antenna directivity effect, but only oriented perpendicularly to the direction of displacement. If the coherent integration is relatively long in relation to the displacement carried out, this synthetic directivity degrades the sensitivity of detection of the signals which do not arrive in the direction perpendicular to the displacement (for example, in the case of a conventional coherent integration of 20 ms for GPS, a speed of displacement creates a synthetic directivity perpendicular to the displacement that is limited to a 3-dB aperture of 5° at 100 m/s, thereby reducing the capacity to detect satellites at other angles of incidence.

Taking the synthetic antenna effect into account right from acquisition makes it possible to also improve the conventional operating robustness of the receivers, by reducing the acquisition times.

In a generic manner, the proposed principle of acquiring and tracking the multiple signals consists:
initially, in locking onto the direct signal by taking account of the carrier's known trajectory when it is available; in the acquisition phase, it is necessary to ascertain the speed vector of the carrier and the satellite's direction (which is determined on the basis of the known ephemerides of the satellites and of an approximate position of the carrier). Lock-on is carried out by searching according to the code delays for the best detection, in the direction of aim,
once the direct signal has been acquired and tracked by the synthetic antenna, the search is carried out for the echoes corresponding to the reflections of the direct signal; the search domain is then slaved to the delay of the direct path undergoing tracking (according to an initial delay and a depth of the delay domain dependent on the application), and the coherent integration is carried out in the direction of the angular domain explored (fixed or scanned).

The invention uses phase measurements after correlation, thus it differs appreciably from the solutions consisting in restoring the coherence of the signals at intermediate frequencies or IF before correlation. This post-correlation processing makes it possible to use the conventional architecture of the known receivers, without significant recasting.

Furthermore, exploiting the sub-carrier of the signals of BOC type to widen the carrier's speed of displacement domain (related to the limitation of the phase calculation frequency) is beneficial for providing a gain in the directions of aim, whatever the speed of displacement of the carrier.

A synthetic antenna effect is reconstructed in the case of a satellite navigation system receiver on the basis of the knowledge of the displacement of the reception antenna (considered to be an elementary sensor) without modifying the conventional reception processing architecture based on phase-locked loops or PLLs and delay-locked loops or DLLs. The antenna effect is obtained by combining the measurements, sampled at various measurement instants, of phase and of amplitude of the tracked signals (complex signal after correlation by the local code).

This coherent combining of the measurements, carried out after compensation of the phase corresponding to the displacement along the axis of sight of the satellite, makes it possible to reconstruct an apparent antenna-related spatial directivity, thus combining under phase coherence the satellite signal of stationary and coherent phase in the direction of aim and in non-coherence for the other sources of interference and of reflection of the direct signals (since there is no correspondence between the evolution of the phase of the jammer with that of the phase compensation specific to the relative direction of displacement of the antenna with respect to the satellite).

This phase compensation processing is carried out for all the processing steps, notably in the acquisition and tracking phase.

Thus, the synthetic aperture antenna device may be oriented in one or more arbitrary directions, and slaved by external control. The amplitude-wise and phase-wise weighting coefficients of the synthetic aperture antenna device are applied to the complex outputs after correlation by the local code, and before coherent integration, and the directivity diagram of the synthetic device may be optimized for each direction of aim, so as to minimize the level of the sidelobes of the spatial directivity function (Hamming weighting, etc.) and minimize the effect of the interference by creating zeros in the directions of the interference sources for example by Capon-type adaptive processing.

The principle relies on the discretization of the measurements of carrier phase in the course of time and before coherent integration. These discrete phase measurements carried out in the course of the displacement of the carrier i.e. of the synthetic aperture antenna device are then analogous to simultaneous measurements sampled with an array antenna, the position of whose antenna elements were to correspond to those discretized along the displacement.

The main limitation of the proposed processing is related to the discretization rate necessary to obtain phase measurements spatially sampled at less than

$$\frac{λ}{2}$$

so that the antenna does not exhibit any angular ambiguity, λ representing the wavelength of the carrier or of the sub-carrier.

The invention makes it possible to increase the signal-to-noise ratio for the extraction of the delay and Doppler measurements at the input of the receiver's tracking loops, to reduce the multipath errors and to eliminate the sources of interference with temporally stationary phase.

This processing is particularly adapted for improving the reception of satellite navigation signals and the robustness to multipaths and to interference or harmonics because of the compensation of the coherence reception phase of the spatial displacement of the reception antenna, of known trajectory.

The advantages of a synthetic aperture antenna device for receiving signals of a satellite navigation system according to the invention are as follows:
simultaneous improvement of the reception sensitivity on the whole set of in-sight satellite signals,
rejection of the specular multipaths outside of the satellite sighting direction,
rejection of the coherent interference sources outside of the satellite sighting direction, and
capacity to reject strong and coherent jamming sources by adaptive processing applied to the equivalent synthetic antenna.

Because of its coherent-integration gain, the synthetic antenna processing may be applied with a view to the acquisition and tracking of the non-direct paths of the satellite signals. This capacity to simultaneously track several propagation paths can find numerous applications with a view to aiding navigation (obstacle avoidance, map-based navigation, altimetry, etc.).

To be identifiable separately from the direct path and be taken into account by this processing, the reflected paths must exhibit a delay greater than the code's temporal correlation domain.

Once the acquisition and tracking of the direct signal have been carried out, the reflected signals are polled at the output of one or more channels of the synthetic antenna device, doing so in a code delay domain that is compatible with the expected “depth”, dependent on the altitude of the carrier. The search for the delay of the code received during acquisition is carried out conventionally by testing the various assumptions about the delay of the local code in the expected domain. Each elementary coherent integration of the signal is carried out after correlation by the local code, clamped onto the delay to be tested, but after compensation of the phase of the local code with respect to the carrier displacement phase projected in the direction of aim by the antenna.

It is noteworthy that the receivers of signals of a satellite navigation system with phase loop and code delay slaving, conventionally carry out a compensation of the travel of the carrier through loop filters and numerically-controlled oscillators NCO, which allows the real-time upkeep of the code and carrier phases generated for the demodulation of the signal received. This upkeep of the carrier position is equivalent to that afforded by the a priori knowledge of the carrier trajectory. FIG. 2 schematically illustrates such a receiver.

The carrier loop makes it possible to estimate, in real time, the relative evolution of the carrier phase and to correct it, doing so on the basis of the carrier phase discriminator 208, of the carrier loop filter 209 and of the carrier numerically-controlled oscillator 202.

Likewise, the code loop makes it possible to estimate, in real time, the relative evolution of the code delay and to correct it, doing so on the basis of the code delay discriminator 206, of the code loop filter 207 and of the code numerically-controlled oscillator 204.

The coherent integration 205 carried out after demodulation of the carrier and of the adapted code carries out then an integration with stationary phase in the direction of the satellite signal, equivalent to a synthetic antenna, also uses two multipliers 201 and 203.

However, in the case of GPS signals, the duration of coherent integration is limited by the duration of the data bits of the messages (20 ms), there is no means of orienting the beam of the synthetic antenna thus created in a different direction from that of the satellite on which the code and phase loops are locked on, and there is no possibility of applying a spatial weighting to the demodulated signal before coherent integration.

In the case where the codes received are modulated by the data, for example in the case of the current GPS signals, the duration of coherent integration of the correlation function is limited by the rate of these data (for example, 20 ms in the case of GPS signals or Galileo data channels), thereby affording a synthetic antenna effect equivalent to a linear antenna of 100*0.02=2 m (about 10λ, corresponding to a spatial gain of 10 dB) in the case of a speed of the carrier i.e. of the receiver of 100 m/s.

The data-less pilot channels available with the new signals allow larger durations of integration, for example the period of the codes of Galileo pilot channels is 100 ms, i.e. an apparent antenna length of 10 m (about 50λ, corresponding to a spatial gain of 17 dB) in the same case of speed of the carrier i.e. of the receiver of 100 m/s.

A reception synthetic aperture antenna device according to the invention makes it possible to ensure larger coherent durations of integration, by prolonging the coherent integration of the phase measurements obtained at the PLL phase loop output, by virtue of the compensation of the motion of the carrier projected onto the antenna sighting direction, for the duration of this integration. It also makes it possible in the acquisition phase to define the angle of sighting of the antenna corresponding to the expected direction of detection of the signal.

An implementation with less impact of the principle of the synthetic antenna in the current architecture of receivers of signals of a satellite navigation system involves tapping off the phase (and not phase increment) information and amplitude information (arising from the imaginary and real parts, I and Q) after coherent integration obtained after code demodulation), at a rate compatible with the displacement carried out, since it is desirable for the spatial sampling to comply with Shannon so as to avoid image lobes, therefore of the order of an ms for an aeroplane, and over a duration corresponding to the desired size of the antenna device (at the maximum of the order of a metre, so as not to have too narrow a directivity pencil, to sight the direction of the satellite without too many constraints on the refresh timing and of precision on the stability of the attitude of the carrier and of stability of the clock of the receiver).

FIG. 3 schematically illustrates an embodiment of the invention in coherent acquisition on simple carrier. The elements represented dashed represent elements present in a conventional device for receiving signals of a satellite navigation system.

The module 301 performs the determination of the search domains for the delays and Doppler (corresponding to the shifts in time and frequency of the signal received in the delay domain and of possible relative speed between satellite and receiver) on the basis of the trajectory of the carrier (i.e. a priori knowledge of the position of the receiver and knowledge of the ephemerides, or else of the a priori knowledge of the propagation delays obtained by model. On the basis of the output signals of the module 301, a Doppler exploration module 302 makes it possible to explore successively the various frequency shift assumptions for the carrier received, by piloting the value of the reference carrier frequency according to the Doppler assumption. A carrier numerically-controlled oscillator 303 makes it possible to generate the NCO signal at the expected frequency of the Doppler channel. The signal received S(t) is multiplied by a multiplier 304 by the output signal from the carrier numerically-controlled oscillator 303.

A module 305 for temporal synchronization of measurements makes it possible to synchronize the modelling of carrier reference trajectory on the basis of times of the receiver by the provision of a common clock. The output signal from the module 305 allows the module 306 to determine the speed of displacement of the carrier, i.e. of the device \vec{V}ₚ. On the basis of the speed of displacement the module 307 calculates the phase evolution of the received signal corresponding to the projection of the speed of displacement of the device in the direction of the signal received, on the basis of the direction of sighting \vec{d} and a reinitialization of the phase origin date applied in a manner synchronous with the initialization of the coherent integration carried out by the module 307. This phase evolution is used by a numerically-controlled oscillator 308 to correct the phase of the carrier. A multiplier 309 multiplies the output signals from the multiplier 304 and of the numerically-controlled oscillator 308.

A module 310 for generating the delays makes it possible to successively explore the various time shift assumptions for the code received, by piloting the delay of the local reference code according to the delay assumption for the signal received on the basis of the output signal delivered by the module 301. The output signal from the module 310 is used by a code numerically-controlled oscillator 311 makes it possible to generate the local reference code with the controlled delay. A multiplier 312 performs the product of the output signals from the numerically-controlled oscillator 311 and of the output signal from the multiplier 309. The signal resulting from the multiplier 312 is integrated by a coherent-integration module 313 over a duration T relating to a particular position of the delay of the local signal undergoing testing. The various delays of the local code in the domain to be explored are then tested, giving rise at each delay increment to a reinitialization of the coherent integrator and of the phase compensation in the direction of aim.

The estimation of the power of the received signal is performed by quadratic detection by means of a module 314 for calculating the modulus squared and of a non-coherent-integration module 315 for searching for the maximum.

FIG. 4 schematically illustrates an embodiment of the invention for coherent tracking on simple carrier. It is recalled that the elements having one and the same reference are similar, even if in this signal tracking embodiment, certain elements are arranged differently, as represented in FIG. 4.

A module for short integration 401 over a duration Tp allows the spatial sampling of the phase along the displacement of the carrier, i.e. of the device (for example, a short integration over a duration Tp of 1 ms corresponds to a phase sampling distance of 5 cm or less for a carrier speed of less than 50 m/s).

Furthermore, for signal tracking, the device comprises a code delay discriminator module 402 (of prompt-delta type, or narrow correlator or else Double-delta) for estimating the error in the time received, and which error is itself delivered to a code loop filter 403 whose order and passband are suited to the carrier dynamics, with or without aid from the more precise phase loop, and making it possible to filter the time errors according to a compatible evolution model this dynamics delivering the filtered delay correction setpoint destined for the code numerically-controlled oscillator 311.

Moreover, for the signal tracking, the device comprises a carrier phase discriminator module 404 (of simple or extended arc-tangent type) for estimating the error of the carrier phase, which is itself delivered to a carrier loop filter 405, and making it possible to filter the phase error according to a compatible evolution model this dynamics delivering the filtered carrier phase correction setpoint destined for the carrier numerically-controlled oscillator 303.

As long as the directivity corresponding to the displacement of the antenna over the duration of short integration Tₚ remains weakly marked (i.e. as long as the apparent length of the antenna related to the displacement of the carrier over the duration Tₚ remains small with respect to the wavelength of the carrier in the previous example, aperture of the main lobe of the directivity function of the synthetic antenna at −3 dB of 200° for a short integration of 1 ms and for a carrier speed of 50 m/s, it is also possible to track the signal in different directions in parallel.

This parallel tracking of channels whose directivity functions intersect one another to better than −3 dB of the maximum of the main lobe of each channel of the directivity function of the synthetic antenna related to the displacement of the carrier over the duration Tₚ makes it possible to carry out an angular interpolation between the adjacent channels so as to determine the position of the maximum for a precise determination of the angle of incidence of the signal. The benefit of this capacity for locating the sources is of interest in tagging the directions corresponding to the strongest reflections of the direct signal by the ground (bright spots).

Current GPS signals are based on a BPSK code modulating the carrier, the tracking phase is therefore that of the carrier, once the code has been demodulated. This requires that the sampling period for the phase measurements be compatible with the spatial sampling frequency of the synthetic aperture antenna device, therefore that the distance separating two phase measurements does not exceed

$$\frac{λ}{2}$$

(λ representing the wavelength of the carrier) of the carrier frequency.

In the case of GPS, L1 (band of emission frequencies of GPS signals under C/A (C/A standing for “Coarse-Acquisition” signal open to civilian users of GPS, initially dedicated to accelerating the acquisition of the enciphered code P(Y)), λ/2 is of the order of about 10 cm, the GPS codes are periodic of period 1 ms (lower bound of duration of correlation). It is therefore impossible to process speeds of displacement of greater than 100 m/s without creating spatial ambiguities: Vp=100 m/s=>Te=(λ/2)/Vₚ=0.1/100=1 ms, Tₑ representing the sampling period for the demodulated signal (equivalent to Tₚ). The higher the speed of displacement, the higher the rate of compensation of the inherent displacement of the carrier must be, this being a limitation to the application of this technique to the field of space GPS receivers (the apparent speed of MEO satellites being greater than 1000 m/s, sampling at 1 kHz leads to a spatial sampling every metre, this being much greater than the spatial sampling constraint at λ/2, equal to 20 cm for the frequency L1).

There also exist satellite navigation systems with modulation of the spreading codes of BOC or ALTBOC type relying on a sub-carrier of the order of 2 MHz to 20 MHz. The signals of the Galileo system are of BOC type.

The phase of the sub-carrier of the BOC code may be tracked by the code loop of the receiver in the same way as the phase of the carrier. The synthetic antenna processing can therefore be applied by coherent integration of the phase of the sub-carrier of the code.

The use of the sub-carrier of the BOC signals makes it possible to go beyond the coherent integration limit fixed by the loop band (passband defined by the loop filter, whose minimum width is fixed by the dynamics of the carrier so as to reduce the slippage errors). The wavelength of the sub-carrier is much larger than that of the carrier. The wavelength of the carrier is short (about 20 cm), and the duration of coherent integration of the phase loop is limited by the speed of variation of the residual phase errors that are due to the dynamics (in the presence of fast evolution of the dynamics of the carrier and of a loop filter of given order, it is necessary that the loop integration time not be too large so as not to introduce any slippage effect) of the carrier, i.e. of the device. The sub-carrier frequency being markedly less than that of the carrier, it is possible to track the sub-carrier phase at a much lower rate, while remaining compatible with dynamics tracking errors that are compatible with the carrier loop (the carrier loop allows short-term tracking of the evolution of the phase of the carrier, with a relatively wide band, ensuring good robustness to the evolution of the carrier dynamics; the residual phase errors relative to the sub-carrier frequency are then negligible, and permit a significant reduction in the sub-carrier loop band (or else a long coherent integration duration)).

The use of the sub-carrier entails an increase in a ratio of 75 to 750, according to the BOC-type code used, in the limit of the speed of displacement of the reception synthetic aperture antenna device, on account of the ratio of the carrier and sub-carrier frequencies.

This device offers an aid to the carrier phase tracking (precise but ambiguous after coherent integration) by the sub-carrier loop (less precise but unambiguous).

The use of a trajectory model for the carrier i.e. for the device is also possible in numerous cases of applications, such as the space, railway, and hybridized aeronautical fields, and furthermore makes it possible to maintain the conventional architecture of short-term phase loops (which is related to the short duration of integration specific to the carrier loop filter).

In FIG. 5 is schematically represented an embodiment of the invention on sub-carrier frequency of BOC type.

The signal received S(t) is multiplied by the multiplier 304 by the output signal of the carrier numerically-controlled oscillator 303, so as to deliver a signal destined for a module 501 for complex demodulation of the BOC-type modulation by multiplication of the signal received by a multiplier 502 carrying out the multiplication with the BOC local code modulated sine-wise (BOC_sine) and a multiplier 503 carrying out the multiplication with the BOC local code in quadrature modulated cosine-wise (BOC_cosine). The code numerically-controlled oscillator 311 generates the local codes BOC-sin and BOC-cos slaved in time to the time received and transmits it to the multipliers 502 and 503.

The output signals from the multipliers 502 and 503 are transmitted to a short-integration module 504 which integrates the signals over a duration of less than or equal to 20 ms so as to transmit the results to the carrier phase discriminator 404. The signals resulting from the short-integration module 504 are also transmitted to a multiplier 505.

The measurements time synchronization module 305 makes it possible to synchronize the carrier reference trajectory modelling with the time base of the receiver by the provision of a common clock. The time synchronization signal of the module 305 is transmitted to the trajectory reference module 506 of the device which delivers as output destined for a module 507 for estimating the speed of relative displacement of the carrier, i.e. of the device \vec{V}ₚ, corresponding to the projection of the speed of displacement of the carrier in the direction of aim. This speed is transmitted to a module 508 for compensating the sub-carrier phase whose output signal is transmitted to the multiplier 505. The output signals from the multiplier 505 as well as the output signals from the measurements time synchronization module 305 are integrated by a long-integration module 509 over a duration of several seconds, (duration to be modulated according to the desired apparent length of the antenna).

The results of the long integration are transmitted to the module 510 for measuring the sub-carrier phase, by Arctangent discrimination (calculation of the phase of the complex error signal by arc-tangent).

The main interest in respect of the reception of the signals is that the sub-carrier makes it possible to increase the duration of coherent correlation of the code (the sub-carrier phase in fact being the observation of the phase of the code) thereby improving the sensitivity (and in rejection of the coherent sources in the other directions), as a function of the apparent length of the antenna expressed in terms of sub-carrier wavelength.

The synthetic antenna gain results from the two integration effects:
the, short-term, coherent-integration gain in the carrier phase (100 ms at the maximum), intrinsic to the phase loop,
the coherent-integration gain in the sub-carrier phase, based on a reference carrier trajectory, that may reach as much as several seconds (for example, in the case of a satellite at 1000 m/s, a duration of integration of 10 s leads to a synthetic antenna length equivalent to 30λ, in the case of a signal of BOC(1,1) type, i.e. a gain of the order of 17 dB).

If the position of last instant of measurement is retained as phase reference of the antenna thus constructed, this processing does not introduce any appreciable latency.

The diversity of the new satellite navigation system codes makes available several wavelengths (flexibility/variety of the codes emitted) which makes it possible to widen the range of speeds of the carrier to which the principle of the synthetic antenna, i.e. of the synthetic aperture antenna device, applies.

The spatial sampling being limited by the internal timing of the processing operations for despreading the codes (the fastest codes being 1 ms), it is not permitted (on account of the compliance with Shannon's sampling principle, necessary so as to avoid spatial ambiguities) for the displacement of the carrier to be greater than

$$\frac{λ}{2} ,$$

λ corresponding to the wavelength of the carrier or of the sub-carrier considered, over the timing period.

Thus in the case of GPS for which C/A L1 equals 1.575 GHz the maximum speed of displacement is 0.1/0.001=100 m/s, therefore difficult to use for aeronautical applications, whereas the use of the sub-carrier of a signal of BOC (1,1) E1 type (E1: Galileo emission frequency) implies a limit speed of the device of 300/0.001=300 km/s; the aeronautical receivers conventionally operating rather at the rate of 20 ms, the maximum speed in the latter case becomes 300/0.02=1500 m/s.

The use of the sub-carrier enables such a device to be used for aeronautical and space applications.

The explanatory mathematical formulations now follow.

A) Carrier-frequency-based synthetic antenna effect in the case of a simple BPSK modulation:
Let S(t) be the signal emitted, composed of a broadband modulation term and of a carrier may be written:

S(t)=C(t)×exp(2jπ·f₀·t)

T representing the time,
C(t) representing C(t) representing the pseudo-random spreading code (BPSK) of the signal,
f₀ representing the carrier emission frequency,

At reception, the Doppler-affected signal may be written:

$$R ( t ) = S ( t - τ ) \cdot exp ( 2 jπ \frac{{V}_{r}}{c} {f}_{0} \cdot t ) = C ( t - τ ( t ) ) \times exp ( 2 jπ \cdot {f}_{0} \cdot ( t - τ ( t ) ) ) \times exp ( 2 jπ \frac{{V}_{r}}{c} {f}_{0} \cdot ( t - τ ( t ) ) )$$

τ representing the satellite-receiver propagation delay,
Vᵣ representing the relative speed of the satellite with respect to the receiver,
c representing the speed of light,
After convergence of the frequency loop following acquisition the signal may be written in baseband:

$${R}_{BB} ( t ) = C ( t - τ ( t ) ) \times exp ( - 2 jπ \cdot {f}_{0} \cdot τ ( t ) ) \times exp ( - 2 jπ \frac{{V}_{r}}{c} {f}_{0} \cdot τ ( t ) )$$

After correlation by the local code the correlation function obtained may be written:

$${Γ}_{R} ( 0 , t ) = {Γ}_{C} ( τ ( t ) ) \times exp ( - 2 jπ \cdot {f}_{0} \cdot τ ( t ) ) \times exp ( - 2 jπ \frac{{V}_{r}}{c} {f}_{0} \cdot τ ( t ) )$$

Γ_{C} representing the spreading code correlation function,

Let furthermore, neglecting the relative Doppler term:

Γ_{R}(0,t)=Γ_{C}(τ(t))×exp(−2jπ·f₀·τ(t))

Let {tᵢ}_{i=1,N} be the set of measurement instants.

The observable measurements for the reconstruction of the synthetic antenna is:

{Γ_{R}(0,tᵢ)}_{i=1,N}

The signal output by the synthetic antenna may be written (in the case of a simple channel formation):

$${Z}_{R} ( k ) = {\sum }_{i = 1}^{N} {Γ}_{R} ( 0 , {t}_{i} ) \times exp ( - 2 jπ \cdot {f}_{0} \cdot \frac{{\vec{p}}_{R} ( {t}_{i} )}{c} \cdot {\vec{s}}_{k} ( {t}_{i} ) )$$

k being the index of the satellite,
\vec{s}ₖ(tᵢ) being the direction vector of the satellite seen from the receiver, at the instant tᵢ
\vec{p}_{R}(tᵢ) is the position vector of the antenna at the instant ₜᵢ,
or:

$${Z}_{R} ( k ) = {\sum }_{i = 1}^{N} {Γ}_{C} ( τ ( {t}_{i} ) ) \times exp ( 2 jπ \cdot {f}_{0} \cdot ( τ ( {t}_{i} ) - \frac{{\vec{p}}_{R} ( {t}_{i} )}{c} \cdot {\vec{s}}_{k} ( {t}_{i} ) ) )$$

By assuming the position of the device to be known at each instant:

$$τ ( {t}_{i} ) = \frac{{\vec{p}}_{R} ( {t}_{i} )}{c} \cdot {\vec{s}}_{k} ( {t}_{i} )$$

By assuming that the length of the antenna remains small compared with the code chip length, the power received in the direction of the satellite becomes:

Z_{R}(k)=Σᵢ₌₁^{N}Γ_{C}(τ(tᵢ))≈N·Γ_{C}(τ(t₀)

Likewise for any coherent interference source appearing in any other direction:

$$\begin{matrix}{Z}_{R} ( k ) = {Γ}_{C} ( τ ( {t}_{0} ) ) \cdot {\sum }_{i = 1}^{N} exp ( 2 jπ \cdot {f}_{0} \cdot ( {τ}_{J} ( {t}_{i} ) - \frac{{\vec{p}}_{R} ( {t}_{i} )}{c} \cdot {\vec{s}}_{k} ( {t}_{i} ) ) ) \\ = {Γ}_{C} ( τ ( {t}_{0} ) ) \cdot \\ {\sum }_{i = 1}^{N} exp ( 2 jπ \cdot {f}_{0} \cdot ( \frac{{\vec{p}}_{R} ( {t}_{i} )}{c} \cdot {\vec{s}}_{J} ( {t}_{i} ) - \frac{{\vec{p}}_{R} ( {t}_{i} )}{c} \cdot {\vec{s}}_{k} ( {t}_{i} ) ) ) \\ = {Γ}_{C} ( τ ( {t}_{0} ) ) \cdot {\sum }_{i = 1}^{N} exp ( 2 jπ \cdot {f}_{0} \cdot ( \frac{{\vec{p}}_{R} ( {t}_{i} )}{c} \cdot ( {\vec{s}}_{J} ( {t}_{i} ) - {\vec{s}}_{k} ( {t}_{i} ) ) ) ) \\ = {Γ}_{C} ( τ ( {t}_{0} ) ) \cdot D ( {\vec{s}}_{J} ( {t}_{i} ) - {\vec{s}}_{k} ( {t}_{i} ) )\end{matrix}$$

where D is the directivity function of the equivalent antenna.

B) Sub-carrier-frequency-based synthetic antenna effect in the case of a BOC-type modulation:

In the case of a BOC sine modulation the signal emitted may be written:

S(t)=C_{BOC}_{ₛ}(t)×exp(2jπ·f₀·t)=C_{BPSK}(t)×sin(2π·Δf·t)×exp(2jπ·f₀·t)

C_{BOC}_{ₛ} representing the BOC spreading code of the signal,
C_{BPSK} representing the BPSK component only of the BOC modulation,

At reception, the delayed signal may be written:

R(t)=S(t−τ(t))=C_{BPSK}(t−τ(t))×sin(2πΔf(t−τ(t)))×exp(2jπ·f₀·(t−τ(t)))

After demodulation of the carrier frequency the signal may be written in baseband:

R_{BB}(t)=C_{BPSK}(t−τ(t))×sin(2πΔf(t−τ(t)))×exp(−2jπ·f₀·τ(t))

After correlation by the local code by a signal of BOC sine type the correlation function obtained may be written:

Γ_{R}(0,t)=τ_{C}_{_{BPSK}}(τ(t))×cos(2πΔ·f·τ(t))exp(−2jπ·f₀·τ(t))

To show the sub-carrier phase term, the correlation of the BOC sine spreading code of the signal received with a BOC cosine local spreading code is carried out in parallel, (cf. FIG. 5) in accordance with the following figure, thus leading to:

Γ_{R}_{_{cs}}(0,t)=Γ_{C}_{_{BPSK}}(τ(t))×sin(2πΔ·f·τ(t))×exp(−2jπ·f⁰·τ(t))

The sum of the two components makes it possible to retrieve the sub-carrier phase information:

$$\begin{matrix}{Γ}_{R} ( 0 , t ) = {Γ}_{{R}_{ss}} ( 0 , t ) + j \cdot {Γ}_{{R}_{cs}} ( 0 , t ) \\ = {Γ}_{{C}_{BPSK}} ( τ ( t ) ) \times exp ( 2 π \cdot Δ f \cdot τ ( t ) ) \times exp ( - 2 jπ \cdot {f}_{0} \cdot τ ( t ) )\end{matrix}$$

It is at this level that the principle is distinguished from that of the carrier-phase-based synthetic antenna. Indeed, to be able to exploit the phase of the sub-carrier, it is necessary to have previously been able to delete the residual carrier phase term, which rotates much more quickly than that of the sub-carrier. This is carried out by previously applying the conventional carrier phase loop (PLL) at the short-term correlation output which will follow and will compensate the carrier phase.

After convergence of a first-order phase loop, the correlation output signal may be written:

$$\begin{matrix}{Γ}_{R} ( 0 , t ) = {Γ}_{{R}_{ss}} ( 0 , t ) + j \cdot {Γ}_{{R}_{cs}} ( 0 , t ) \\ = {Γ}_{{C}_{BPSK}} ( τ ( t ) ) \times exp ( 2 π \cdot Δ f \cdot τ ( t ) ) \times \\ exp ( - 2 jπ \cdot {f}_{0} \cdot \frac{{\partial }^{2} τ ( t )}{\partial {t}^{2}} Δ t\end{matrix}$$

after having put,

$$τ ( t ) = {τ}_{0} + {\int }_{0}^{Δ t} \frac{{V}_{r} ( u )}{c} d u$$

$${Γ}_{R} ( 0 , t ) = {Γ}_{{C}_{BPSK}} ( τ ( t ) ) \times exp ( 2 π \cdot Δ f \cdot τ ( t ) ) \times exp ( - 2 jπ \cdot \frac{{f}_{0}}{c} \frac{\partial {V}_{r} ( t )}{\partial t} Δ t )$$

The measured total phase is therefore composed of the sub-carrier phase, that one desires to estimate, and of the residual error of the phase loop. For a good estimation of the sub-carrier phase, it is therefore necessary for the residual carrier phase error (due to the dynamics error and to thermal noise) to remain low.

The aim of the device being to provide increased robustness in the estimation of satellite pseudo-distances, it is indispensable that the phase loop be aided, i.e. by an inertial reference so as to provide a precise aid in terms of speed (to be explained) to the phase loop.

However, it is not necessary for the inertial references to exhibit good long-term stability, only short-term stability (over Δt) is required, thereby allowing the use of low-cost MEMS.

The carrier phase thus being re-adjusted over each time increment so as to limit the error in the sub-carrier phase, it becomes possible to use just the code information to reconstruct through the synthetic antenna effect an unambiguous code phase measurement (phase of the sub-carrier) that is markedly more precise and robust than a pseudo-distance code measurement obtained by a conventional (instantaneous) BOC-type modulation.

These precise pseudo-distance measurements make it possible to obtain a precise estimation of the position, by benefiting from the spatial filtering carried out by the antenna to reject the interference sources and make it possible for the tracked satellites to be better isolated from one another.

The residual correlation term (for demodulating the sine BOC with the local sine BOC) then becomes:

Γ_{R}_{_{CC}}(0,t)=Γ_{C}_{_{BPSK}}(τ(t))×exp(2πj·Δf·τ(t))

Let {tᵢ}_{i=1,N} be the set of measurement instants.

The observable measurements for the reconstruction of the synthetic antenna are:

{Γ_{R}(0,tᵢ)}_{i=1,N}

The signal output by the synthetic antenna may be written (in the case of a simple channel formation):

bb
k being the index of the satellite,
\vec{s}ₖ(tᵢ) is the direction vector of the satellite seen from the receiver, at the instant tᵢ
\vec{p}_{R}(tᵢ) is the position of the antenna at the instant tᵢ
or;

$${Z}_{R} ( k ) = {\sum }_{i = 1}^{N} {Γ}_{C} ( τ ( {t}_{i} ) ) \times exp ( 2 jπ \cdot Δ f \cdot ( τ ( {t}_{i} ) ) \times exp ( - 2 jπ \cdot Δ f \cdot \frac{{\vec{p}}_{R} ( {t}_{i} )}{c} \cdot {\vec{s}}_{k} ( {t}_{i} ) ) )$$

By assuming the position of the device to be known at each instant:

$$τ ( {t}_{i} ) = \frac{{\vec{p}}_{R} ( {t}_{i} )}{c} \cdot {\vec{s}}_{k} ( {t}_{i} )$$

By assuming that the length of the antenna remains small compared with the length of a code snippet (the code snippet corresponds to a the unit element of modulation of the code phase), the power received in the direction of the satellite becomes:

Z_{R}(k)=Σᵢ₌₁^{N}Γ_{C}(τ(tᵢ))≈N·Γ_{C}(τ(t₀))

Likewise for any coherent interference source appearing in any other direction:

$$\begin{matrix}{Z}_{R} ( k ) = {Γ}_{C} ( τ ( {t}_{0} ) ) \cdot {\sum }_{i = 1}^{N} cos ( 2 jπ \cdot {f}_{0} \cdot ( {τ}_{J} ( {t}_{i} ) - \frac{{\vec{p}}_{R} ( {t}_{i} )}{c} \cdot {\vec{s}}_{k} ( {t}_{i} ) ) ) \\ = {Γ}_{C} ( τ ( {t}_{0} ) ) \cdot {\sum }_{i = 1}^{N} exp ( 2 jπ \cdot {f}_{0} \cdot ( \frac{{\vec{p}}_{R} ( {t}_{i} )}{c} \cdot {\vec{s}}_{J} ( {t}_{i} ) - \frac{{\vec{p}}_{R} ( {t}_{i} )}{c} \cdot {\vec{s}}_{k} ( {t}_{i} ) ) ) \\ = {Γ}_{C} ( τ ( {t}_{0} ) ) \cdot {\sum }_{i = 1}^{N} exp ( 2 jπ \cdot {f}_{0} \cdot ( \frac{{\vec{p}}_{R} ( {t}_{i} )}{c} \cdot ( {\vec{s}}_{J} ( {t}_{i} ) - {\vec{s}}_{k} ( {t}_{i} ) ) ) ) \\ = {Γ}_{C} ( τ ( {t}_{0} ) ) \cdot D ( {\vec{s}}_{J} ( {t}_{i} ) - {\vec{s}}_{k} ( {t}_{i} ) )\end{matrix}$$

D being the directivity function of the equivalent antenna.

The antenna effect is obtained by combining the measurements (sampled at the measurement instants) of phase and of amplitude of the complex signal obtained after correlation by the local code. This coherent combining of the measurements, after compensation of the phase corresponding to the displacement along the axis of sight of the satellite, makes it possible to reconstruct an apparent antenna-related spatial directivity, thus combining under phase coherence the signal of the satellite (of stationary and coherent phase in the direction of aim) and under non-coherence for the other sources of interference (since there is no correspondence between the evolution of the phase of the jammer with that of the compensation).

This makes it necessary to sample the information regarding phase, and not phase increments, and amplitude of the complex signal obtained after demodulation, on the basis of its I and Q components after coherent integration, at a rate compatible with the displacement carried out by the device so that the spatial sampling complies with Shannon's constraint to avoid the image lobes of the spatial directivity function. The phase extraction rate is of the order of an ms for an aeroplane. The duration of integration must correspond to the desired size of the antenna, at the maximum of the order of a metre, so as not to have too narrow a directivity pencil, which could pose problems for sighting the direction of the satellite. If the position of last instant of measurement is retained as phase reference of the antenna thus constructed, this processing does not introduce any appreciable latency.

In the presence of strong interference sources, there are no particular constraints on the coding dynamics on account of the spreading of the spectrum carried out by the correlation with the local code. The processing does not therefore demand any significant modifications of the architecture, except for the rate of sampling of the I and Q components of the complex signal obtained after demodulation.

The method makes it possible to increase the signal-to-noise ratio for the extraction of the delay measurements and Doppler measurements at the input of the loops, and before inertial coupling.

As a variant of a device of the figure, as illustrated in FIG. 6, the long-integration module 509 is replaced with an adaptive processing module 609. An adaptive processing such as this can be applied to the carrier phase as well as the sub-carrier phase, as illustrated for the sub-carrier phase by FIG. 6.

The adaptive processing module 609 comprises a module 610 for calculating weightings, and a spatial adaptive processing module 611.

An appreciable advantage of the solution proposed in reception relies on the capacity of the receiver to sample the carrier or sub-carrier phase of the signal received at representative instants of a spatial sampling.

This spatial sampling makes it possible to carry out a coherent spatial integration, as well as to be exploited to reconstruct by weighting elementary phases of an adaptive directivity diagram, based on minimizing the energy received over this set of samples (which is not feasible if a coherent integration is carried out over the same duration). The principle of the antenna processing presented hereinabove may be used to carry out a spatial adaptive processing with the aid of the time-sampled measurements, obtained after correlation.

The spatial adaptive processing is generally applied by sampling in a synchronous manner (at the same instants) the signals originating from spatially separated sensors (spatial sampling), and by calculating the intercorrelation matrix for these various signals over a given temporal horizon dependent on the refresh rate to be achieved.

In the case of the synthetic aperture antenna device, carried out after correlation by the local code 509, the spatial sampling is carried out by timing of the sampling of the signal amplitude and phase measurements after short integration 504 and compensation of the relative displacement of the carrier 506, 507, 508.

We put {W(x(tᵢ+Tₖ)}_{i=1,N}, the complex measurement samples for the time interval Tk.

The compensated measurements thus obtained at the various instants are equivalent to phase and amplitude measurements which would have been sampled by physical sensors sampled along the path traversed by the antenna. {W(xᵢ(Tₖ)}_{i=1,N}, with xᵢ(tₖ)=x(tᵢ+Tₖ).

Hereinafter, the vector of spatial measurements is denoted W. The matrix inversion algorithms apply identically for both types of approaches (physical antenna and synthetic antenna).

The field received on the array is considered to be the superposition of a signal field induced by the useful source of low amplitude and having stationary phase, and of a non-isotropic noise field induced by one or more jammers of strong level, likewise having stationary phase.

The adaptive antenna processing consists in determining the weighting coefficients, adapted to this particular noise field, and which minimize the effects thereof.

Conventionally, the problem may be treated as a constrained optimization problem, posed in the following manner: the noise field being the greatly predominant element in the energy gathered when leaving the conventional processing, we seek the weighting vector W which minimizes this energy e(hᵢ), under the constraint of maintaining a unit gain in the direction of aim D, this being expressed by the condition:

W*D=1

The solution of this optimization problem is well known, only the two essential results of which are recalled here:
a) the optimal weighting vector is related to the pointing direction vector D on the one hand, and to the correlation matrix R on the other hand, by the relation:

$$W = \frac{{R}^{- 1} D}{D * {R}^{- 1} D}$$

b) the energy, resulting from the application to the array of x optimal weighting vector, will then be:

e(hᵢ)=<W*RW>=<(D*R⁻¹D)⁻¹>

The latter result shows that the matrix relation now only involves the pointing vector D and the correlation matrix R, after an inversion operation which may be performed once and for all.

By varying D alone, it is thus possible, just as in conventional processing, to obtain scanning of the space of explored directions, without it being necessary to recalculate, in each direction of aim, the optimal weighting vector W.

This scheme is that of the minimum Capon energy such as described, for example, in “Special Issue on Acoustic Synthetic Aperture Processing, IEEE Ocean Engineering Trans”, Vol. 17, January 1992. It is also much like that of the maximum likelihood, such as described, for example, in . . . (cite reference 5, since it is not mentioned in the note) which leads to an energy at the array output equal to:

e(hᵢ)=<(D*R_{b}⁻¹D)⁻¹>

The matrix R_{b} involved here is the correlation matrix for the noise alone, which must be evaluated in the absence of the source, this not always being possible.

This minimum energy procedure has the advantage of preserving the optimum gain of the conventional processing and therefore of maximizing the signal-to-noise ratio in the direction of the target. It is also recognized as having high-resolution properties, but there are no theoretical bases indicating that this procedure is the best.

X representing the vector of complex amplitudes of the signals of the antenna, the formation of channels consists in constructing a representation of the field received on the antenna as a function of the direction of arrival of the waves θ of the form:

Y(θ)=W+(θ)·X

the channel-forming vector W(θ) satisfies the constraint:

W+(θ)·d(θ)=1

d(θ) is a known vector whose components are the complex amplitudes of the signals induced on the sensors by a wave of unit amplitude received in the direction θ:

$$d ( θ ) T = ( d 1 , … , d i , … , d N )$$

$$with {d}_{i} = exp [ j \frac{2 π {u}_{θ}^{T} {r}_{i}}{λ} ]$$

u_{θ}=unit vector in the direction θ
rᵢ=vector of coordinates of sensor i

Conventional channel forming consists in re-phasing the signals received on the antenna for a particular direction θ and in summing them.

The channel-forming vector is then:

$${W}_{C} ( θ ) = \frac{1}{N} d ( θ ) .$$

The formation of adaptive channels is aimed at minimizing the power of the signal received in the channel, while ensuring the constraint (unit gain in the direction of pointing of the channel).

The vector for forming adaptive channels thus adapts to the characteristics of the field to be observed; thus it will tend to place in the directions of the jammers outside of the direction of the channel formed a low gain, so as to minimize the power of the signal.

The adaptive channel-forming vector is:

$${W}_{a} ( θ ) = \frac{{Γ}^{- 1} \cdot d ( θ )}{{d}^{+} ( θ ) \cdot {Γ}^{- 1} \cdot d ( θ )}$$

Γ being the interspectral matrix of the signals of sensors: Γ=∉[X. X⁺].

The mean powers of the signals of channels are in the cases of the conventional and adaptive channel formations:

$${P}_{c} ( θ ) = \frac{1}{{N}^{2}} {d}^{+} ( θ ) \cdot Γ \cdot d ( θ )$$

$${P}_{a} ( θ ) = \frac{1}{{d}^{+} ( θ ) \cdot {Γ}^{- 1} \cdot d ( θ )}$$

The extraction of the phase of the signal resulting from the adaptive processing 609 is carried out simply by extracting the phase of the complex output signal by calculating the arctangent of the demodulated complex signal.

1. Synthetic aperture antenna device for receiving signals comprising a carrier and means for determining a trajectory, characterized in that the device comprises, for each signal respectively associated with a spatial direction, processing means adapted for generating a signal with stationary phase over a time window corresponding to the distance traversed by the device during the duration of coherent integration, after demodulation of the said signal received, the said processing means comprising correction means adapted for correcting the carrier phase of the said signal.

2. The device according to claim 1, adapted for receiving signals from a satellite navigation system.

3. The device according to claim 2, in which the said correction means comprises, in order to correct the carrier phase of the said signal in the acquisition phase or in the tracking phase:
first means for determining a speed of displacement vector of the device;
means of orthogonal projection of the said speed of displacement vector of the device in the direction of the said signal;
a first numerically-controlled oscillator receiving as input the said orthogonal projection;
a multiplier for multiplying the signal delivered by the said first numerically-controlled oscillator and the complex base components of the signal received, obtained after demodulation of the carrier phase; and
first means of coherent integration of the signal delivered by the said multiplier over a time interval of a duration T that is less than the time of traversal by the antenna of 100 wavelengths of the carrier frequency, and less than a maximum of 10 seconds.

4. The device according to claim 1, in which, the signal comprising a sub-carrier phase, the said correction means is, furthermore, adapted for correcting the sub-carrier phase of the said signal.

5. The device according to claim 4, in which, the sub-carrier phase comprising a modulation of the spreading codes of BOC type, the said correction means comprises:
means of complex demodulation of the sub-carrier phase;
second means of short integration of the signal delivered by the said means of complex demodulation serving for the measurement of the carrier phase;
second means for determining a trajectory reference for the said device so as to determine the evolution of the phase of the signal received corresponding solely to the displacement of the said device;
means for estimating the relative displacement of the device corresponding to the projection of the speed of displacement of the carrier in the direction of the signal received on the basis of the said trajectory reference for the said device;
first means for calculating a sub-carrier phase correction for the signal corresponding to the relative displacement of the carrier, slaved in time to the time received;
first multiplication means for performing the complex multiplication of the output signal of the said second means of short integration and of the said first means for calculating sub-carrier phase correction;
third means of long integration of the signal delivered by the said second means of short integration serving for the measurement of the sub-carrier phase; and
means for measuring the sub-carrier phase.

6. The device according to claim 5, in which the said means of complex demodulation of the sub-carrier phase comprises:
a second numerically-controlled oscillator for generating the local BOC-type code slaved in time to the time received; and
second multiplication means for performing the complex multiplication of the signal received and of the BOC-type code generated.

7. The device according to claim 4, in which, the sub-carrier phase comprising a modulation of the spreading codes of BOC type, the said correction means comprises:
means of complex demodulation of the sub-carrier phase;
second means of short integration of the signal delivered by the said multiplier serving for the measurement of the carrier phase;
second means for determining a trajectory reference for the said device so as to determine the evolution of the phase of the signal received corresponding solely to the displacement of the said device;
means for estimating the relative displacement of the device corresponding to the projection of the speed of displacement of the carrier in the direction of the signal received on the basis of the said trajectory reference for the said device;
first means for calculating a sub-carrier phase correction for the signal corresponding to the relative displacement of the carrier, slaved in time to the time received;
third means for multiplying the signals delivered at the output of the second means of short integration and of the first calculation means;
spatial adaptive processing means for performing a temporal filtering of the demodulated complex signal, delivered at the output of the said third multiplication means, on the basis of the said weightings and of the said sub-carrier phase measurement; and
second means for calculating weighting coefficients for the said spatial adaptive processing means, applied on the basis of the signal delivered at the output of the said third multiplication means; and
means for measuring the sub-carrier phase of the output signal of the said spatial adaptive processing means.

8. A method of receiving by synthetic aperture antenna signals comprising a carrier and means for determining a trajectory, in which, for each signal respectively associated with a spatial direction, a processing is performed, adapted for generating a signal with stationary phase over a time window corresponding to the distance traversed by a device during the duration of coherent integration, after demodulation of the said signal received, the said processing comprising a correction of the carrier phase of the said signal.

9. The method according to claim 8, in which the said correction of the carrier phase of the said signal comprises, in the acquisition phase or in the tracking phase:
a determination of a speed of displacement vector for the said antenna;
an orthogonal projection of the said speed of displacement vector in the direction of the said signal;
a generation of a signal for correcting the phase of the carrier performed by a digital oscillator controlled phase-wise on the basis of the speed of displacement of the antenna in the direction of the signal;
a multiplication of the said corrected signal and of the signal received in terms of complex base components, obtained after demodulation of the carrier phase; and
a coherent integration of the result of the said multiplication over a time interval of a duration T that is less than the time of traversal by the antenna of 100 wavelengths of the carrier frequency, and less than a maximum of 10 seconds.

10. The method according to claim 8, in which, the signal comprising a sub-carrier phase, the said correction is, furthermore, adapted for correcting the sub-carrier phase of the said signal.

11. The method according to claim 9, in which, the signal comprising a sub-carrier phase, the said correction is, furthermore, adapted for correcting the sub-carrier phase of the said signal.

12. The device according to claim 3, in which, the signal comprising a sub-carrier phase, the said correction means is, furthermore, adapted for correcting the sub-carrier phase of the said signal.

13. The device according to claim 12, in which, the sub-carrier phase comprising a modulation of the spreading codes of BOC type, the said correction means comprises:
means of complex demodulation of the sub-carrier phase;
second means of short integration of the signal delivered by the said means of complex demodulation serving for the measurement of the carrier phase;
second means for determining a trajectory reference for the said device so as to determine the evolution of the phase of the signal received corresponding solely to the displacement of the said device;
means for estimating the relative displacement of the device corresponding to the projection of the speed of displacement of the carrier in the direction of the signal received on the basis of the said trajectory reference for the said device;
first means for calculating a sub-carrier phase correction for the signal corresponding to the relative displacement of the carrier, slaved in time to the time received;
first multiplication means for performing the complex multiplication of the output signal of the said second means of short integration and of the said first means for calculating sub-carrier phase correction;
third means of long integration of the signal delivered by the said second means of short integration serving for the measurement of the sub-carrier phase; and
means for measuring the sub-carrier phase.

14. The device according to claim 13, in which the said means of complex demodulation of the sub-carrier phase comprises:
a second numerically-controlled oscillator for generating the local BOC-type code slaved in time to the time received; and
second multiplication means for performing the complex multiplication of the signal received and of the BOC-type code generated.

15. The device according to claim 12, in which, the sub-carrier phase comprising a modulation of the spreading codes of BOC type, the said correction means comprises:
means of complex demodulation of the sub-carrier phase;
second means of short integration of the signal delivered by the said multiplier serving for the measurement of the carrier phase;
second means for determining a trajectory reference for the said device so as to determine the evolution of the phase of the signal received corresponding solely to the displacement of the said device;
means for estimating the relative displacement of the device corresponding to the projection of the speed of displacement of the carrier in the direction of the signal received on the basis of the said trajectory reference for the said device;
first means for calculating a sub-carrier phase correction for the signal corresponding to the relative displacement of the carrier, slaved in time to the time received;
third means for multiplying the signals delivered at the output of the second means of short integration and of the first calculation means;
spatial adaptive processing means for performing a temporal filtering of the demodulated complex signal, delivered at the output of the said third multiplication means, on the basis of the said weightings and of the said sub-carrier phase measurement; and
second means for calculating weighting coefficients for the said spatial adaptive processing means, applied on the basis of the signal delivered at the output of the said third multiplication means; and
means for measuring the sub-carrier phase of the output signal of the said spatial adaptive processing means.
